(19) United States
(12) Patent Application Publication
(10) Pub. No.: US 2015/0127749 A1
(43) Pub. Date: May 7, 2015

(54) EMAIL THREAD PROCRASTINATING METHOD

(71) Applicant: John Robert MISHANSKI, San Francisco, CA (US)

(72) Inventor: John Robert MISHANSKI, San Francisco, CA (US)

(73) Assignee: GOOGLE INC., Mountain View, CA (US)

(21) Appl. No.: 13/491,543

(22) Filed: Jun. 7, 2012

(51) Int. Cl. H04L 12/58; G06F 15/16

(52) U.S. Cl. CPC H04L 51/02
USPC 709/206

(57) ABSTRACT

A computer-implemented method for procrastinating an email for review at a later time is provided. The method includes identifying an email for procrastination, and selecting a procrastination period. The method also includes procrastinating the identified email, including storing the identified email separately from other emails or email threads stored in an email repository. The method further includes receiving a new email during the procrastination period and identifying if the new email relates to the procrastinated email to form a thread, and if the new email relates to the procrastinated email, storing the new email with the procrastinated email to form a procrastinated email thread. The method further includes communicating all emails related to the procrastinated email thread to the user after expiration of the procrastination period. Systems and machine-readable media are also provided.

### TECHNICAL FIELD

The present disclosure generally relates to managing emails, and more particularly to managing email threads for review at a later time.

### BACKGROUND

Email has become one of the most popular communication tools among many people, and more people are relying on email as their main means of communication. As more communications are conducted through emails, a considerable amount of emails may be delivered to a user's inbox. The emails in the inbox may be part of an active email thread which constantly receives new emails, alerting the email user each time they arrive.

### SUMMARY

The disclosed subject matter relates to a computer-implemented method for procrastinating an email thread for review at a later time. The method includes identifying an email for procrastination, and selecting a procrastination period. The method also includes procrastinating the identified email for review at a later time, comprising storing the identified email separately from other emails or email threads stored in an email repository. The method further includes receiving a new email during the procrastination period and identifying if the new email relates to the procrastinated email to form an email thread, and if so, storing the new email with the procrastinated email to form a procrastinated email thread. The method further includes, after expiration of the procrastination period, communicating all emails related to the procrastinated email thread to the user.

The disclosed subject matter further relates to a system for procrastinating an email thread for review at a later time. The system includes a memory storing a first email repository storing a plurality of emails received for a user, the memory further storing executable instructions. The system also includes a processor coupled to the memory configured to execute the stored executable instructions to identify an email for procrastination, and select a procrastination period. The processor is also configured to procrastinate the identified email for review at a later time, including moving the identified email from the first email repository to a second email repository different from the first email repository. The processor is further configured to receive a new email during the procrastination period and identify if the new email relates to the procrastinated email to form an email thread, and if so, store the new email in the second email repository with the procrastinated email to form a procrastinated email thread. The processor is further configured to move all emails related to the procrastinated email thread to the first email repository after expiration of the procrastination period.

The disclosed subject matter also relates to a machine-readable storage medium comprising machine-readable instructions for causing a processor to execute a method for procrastinating an email thread for review at a later time. The method includes identifying an email for procrastination, and selecting a procrastination period. The method also includes procrastinating the identified email for review at a later time, including moving the identified email from a first email repository to a second email repository, wherein emails stored in the second email repository are not readily visible to a user. The method further includes receiving a new email during the procrastination period and identifying if the new email relates to the procrastinated email to form an email thread, and if so, storing the new email in the second email repository with the procrastinated email to form a procrastinated email thread. The method further includes, after expiration of the procrastination period, moving all emails related to the procrastinated email thread including the new email from the second email repository to the first email repository.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purposes of explanation, several aspects of the subject technology are set forth in the following figures.

FIG. 1 illustrates an example architecture for procrastinating email threads for review at a later time.

FIG. 2 is a block diagram illustrating an example system for procrastinating email threads for review at a later time.

FIG. 3 is a schematic diagram illustrating example operations for procrastinating email threads for review at a later time.

FIG. 4 illustrates an example flow diagram of example processes for procrastinating email threads for review at a later time.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

An email user may wish to use his or her email inbox as an informal to-do list. Emails in the inbox are often part of an email thread. The user may delete, archive, or mute the email thread once the issue the thread relates to is resolved. When an email thread is muted, the user is not notified of future emails received for the email thread. Sometimes the issue may not be resolved, but at the same time the user is unable to act on it immediately and therefore the user may wish to act on it at a later time. Accordingly, the user may wish to put away such an email thread for the time being and be reminded again after a certain period of time. If such email thread is left in the inbox, it would be a distraction to the user. The user would be even more distracted if the email thread is part of a very active discussion. In such case, the user may not want to be distracted by a new email indicator each time a new email comes in for that thread. While the user may mute the email thread, after muting, the user may forget to revisit the muted email thread, especially if the user's inbox is cluttered with other email threads.

According to various aspects of the subject technology, a system and method for procrastinating email threads for review at a later time is provided. The system may provide a user with a user interface for invoking a procrastination command to put away (“procrastinate”) an email thread for a certain period of time, to be reviewed and handled afterwards. The user may select an email thread to procrastinate in an inbox and invoke the procrastinate command. The selected email thread is then designated as a procrastinated email thread and managed separately from other emails or email threads in the inbox such that the user is no longer distracted by the email thread or other incoming new emails associated with the email thread. The thread may be separately managed by, for example, being removed from the inbox into another email repository. The thread may also be tagged as a procrastinated thread and managed through filtering the email threads such that the tagged threads are not shown to the user, if desired. The procrastinated email thread will be kept away from the user's attention for a designated time period (“procrastination period”) or until a designated point in time (“procrastination end time”) and then made prominent to the user after the procrastination period is up. The thread may be made prominent by, for example, delivering the entire thread to the inbox as a new thread, highlighting the thread in the inbox, or sending a message to the user.

A pre-determined default procrastination period may be used. For example, a default procrastination period may be set as 24 hours. A user interface may also be provided such that a user may indicate a custom procrastination period when invoking the procrastination command.

While the email thread is being procrastinated, the system will keep track of any new emails received for the procrastinated email thread. These new emails will not be shown to the user during the procrastination period, but will be shown to the user upon expiration of the procrastination period. After the procrastination period, further new emails which are part of the email thread will be delivered to the inbox and be notified to the user as they arrive.

In an aspect of the invention, rather than keeping away from the user (e.g., hiding or moving to another email repository) all the emails of the procrastinated thread during the procrastination period, existing emails of the procrastinated thread may still be kept in the inbox as usual, but only new emails received for the thread are kept away. The new emails may be kept away by, for example, storing in a separate email repository or hiding from the user's view. Upon expiration of the procrastination period, the new email is made prominent to the user. The new email may be made prominent by, for example, delivering the new email to the inbox as a new email part of the procrastinated thread, highlighting the new email, or sending a message to the user.

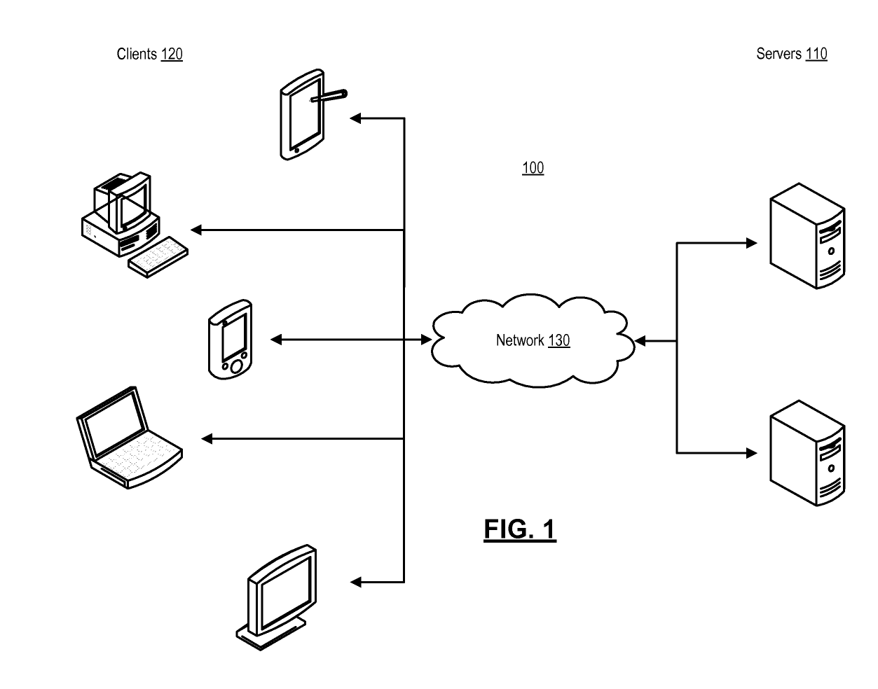

Turning to the drawings, FIG. 1 illustrates an example architecture 100 for procrastinating emails for review at a later time. The architecture 100 includes servers 110 and clients 120 connected over a network 130. Each of the clients 120 may interact with users, and communicate with the servers 110 to manage procrastination of emails for review at a later time. The servers 110 may be any device having an appropriate processor, memory, and communications capability for communicating with the clients 120 and receiving/managing/sending emails. The clients 120 may be, for example, desktop computers, laptop computers, mobile devices (e.g., a smart phone, tablet computer, or PDA), set top boxes (e.g., for a television), televisions, video game consoles, home appliances (e.g. a refrigerator, microwave oven, washer, or dryer) or any other devices having appropriate processor, memory, and communications capabilities.

The network 130 may include, for example, any one or more of a personal area network (PAN), a local area network (LAN), a campus area network (CAN), a metropolitan area network (MAN), a wide area network (WAN), a broadband network (BBN), the Internet, and the like. Further, the network 130 can include, but is not limited to, any one or more of the following network topologies, including a bus network, a star network, a ring network, a mesh network, a star-bus network, tree or hierarchical network, and the like. The architecture 100 may comprise only servers 110, or may comprise only clients 120, in communication with the network 130.

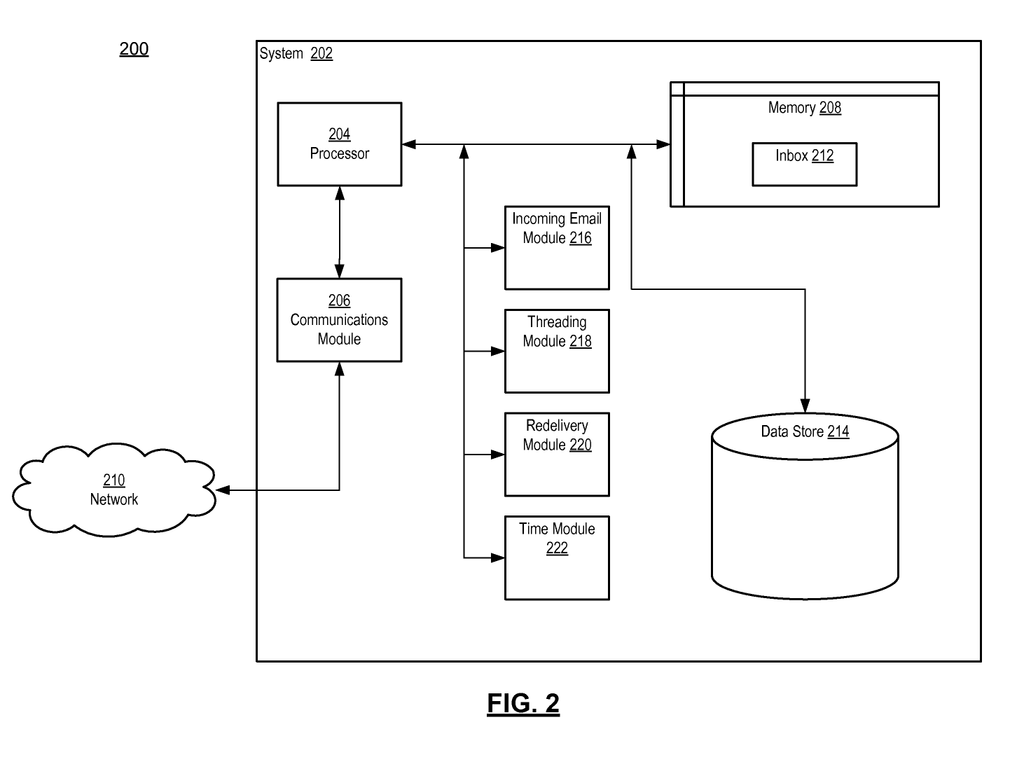

FIG. 2 is a block diagram 200 illustrating an example system 202 for procrastinating email threads for review at a later time. The system 202 may be implemented, for example, in one of the servers 110 or across multiple servers. The system 202 includes a processor 204, a communications module 206, and a memory 208. The system 202 is connected to a network 210 (e.g., network 130) via the communications module 206. The communications module 206 is configured to interface with the network 210 to send and receive information, such as data, requests, responses, and commands to other devices (e.g., clients 120) or systems on the network. The communications module 206 may be, for example, modems, Ethernet cards or mobile broadband adaptors.

The memory 208 includes an inbox 212. The inbox 212 stores emails received by the system 202. The emails in the inbox 212 are readily accessible by the user. New emails arriving at the system are first stored in the inbox 212. The user may view the emails in the inbox 212 and may decide to delete the email, move the email to another location, or to leave the email in the inbox. The emails in the inbox 212 may also be part of an email thread. The entire thread may be deleted or moved to another location. The system also includes a data store 214. The data store 214 may be integrated with the memory 208, or may be independent from the memory 208 and be in communication with the processor 204 and the memory. The data store 214 may also be implemented to be independent from the system 202 and in communication with the system. The data store 214 stores all emails received by the system 202. Emails arriving in the inbox 212 are copied onto the data store 214. Emails in the inbox 212 may also be moved into the data store 214. The emails arriving at the system 202 may also be sent directly to the data store 214 without first being placed in the inbox 212. The data store 214 also records the statuses of the emails stored within. Such statuses indicate, for example, whether the emails are read or unread by the user, or whether they are part of a thread. The data store 214 may also mark the emails with information such as, for example, whether the emails, or the threads which the emails are part of, are procrastinated for review at a later time. The end time of the procrastination period for the procrastinated emails is also stored in the data store 214.

The system 202 also includes an incoming email module 216, a threading module 218, a redelivery module 220, and a time module 222. The incoming email module 216 stores instructions for receiving emails arriving at the system 202 and directing the email to the inbox 212 and/or other predetermined location, such as the data store 214. The threading module 218 stores instructions for determining whether the received email is a message that is part of an existing email thread stored in the inbox 212 or the data store 214, and identifying the received email accordingly. If the received email is identified as a message of an existing email thread, association is made with the existing thread and the received email is stored in the inbox 212 and/or the data store 214 according to the location and status of the existing email thread.

The redelivery module 220 stores instructions for redelivering procrastinated emails or email threads to the inbox 212 at the end of the procrastination period. The time module 222 stores instructions for determining the end of the procrastination period for the procrastinated emails or email threads. The instructions of modules 216, 218, 220 and 222 may be executed by the processor 204. The modules 216-222 may also be stored in the memory 208 and may be part of other software which may be executed by the processor 204. The modules 216-222 may also be implemented as independent hardware modules in communication with the processor 204.

The processor 204 is configured to execute instructions, such as instructions physically coded into the processor, instructions received from software in memory 208, or a combination of both. For example, the processor 204 is configured to execute instructions to identify an email thread to procrastinate. A procrastinate command is also received from the user to procrastinate the identified email thread for review at a later time. The processor is also configured to determine the procrastination period. Information for determining the procrastination period may be received from the user. Such information may be received in the form of a duration of time, or in the form of a specific end time. Based on the duration of time or the end time received from the user, the procrastination period is determined. Default value such as, for example, 24 hours, may also be predefined and determined as the procrastination period if no value is received from the user. The processor is further configured to receive a new email for the procrastinated email thread during the procrastination period, and separate the new email from other emails in an email repository for the duration of the procrastination period. The email repository may be, for example, the inbox 212 or the data store 214.

The new email for the procrastinated email thread may be processed such that it is not made readily visible to the user during the procrastination period. For example, the new email is moved from an inbox to a different data store such that the user may not immediately view the new email. As another example, the new email for the procrastinated email thread remains in the same repository as the other emails, but is not displayed to the user. The user may still have access to the new email for the procrastinated email thread during the procrastination period. For example, the user may perform a search to access the new email during the procrastination period. A user interface such as, for example, a “show all procrastinated emails” check box may also be provided such that the user may check on the check box to view all emails that are part of the procrastinated email thread.

The processor 204 is yet further configured to communicate to the user the new email for the procrastinated email thread after the expiration of the procrastination period. For example, if the new email had been moved to another data store during the procrastination period, then the new email is moved back into the inbox. If the new email for the procrastinated email thread had remained in the same email repository but was not shown to the user, the new email is again made visible to the user. Such email is identified as having returned from being procrastinated, or otherwise displayed to be stood out from the rest of the emails of the procrastinated email thread (e.g., emails of the email thread that were received before procrastination). For example, such email may be marked as a new email in the inbox, or a separate marker may be provided to mark the email as having been returned from procrastination.

In an aspect of the invention, rather than separating only the new emails for the procrastinated email thread, the processor 204 is configured to separate the entire procrastinated email thread during the procrastination period from the rest of the emails of the email repository. The processor 204 is further configured to communicate all emails of the procrastinated email thread back to the user after the expiration of the procrastination period. New emails for the procrastinated email thread received during the procrastination period will still be communicated, only after the procrastination period, along with the rest of the procrastinated email thread.

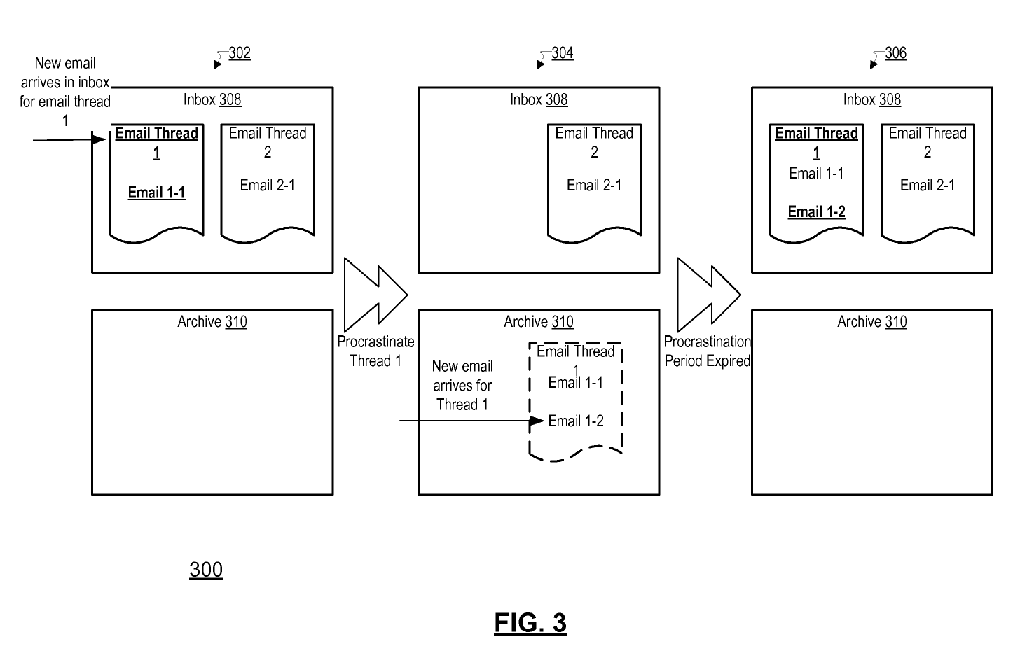

FIG. 3 is a schematic diagram 300 illustrating example operations for procrastinating email threads for review at a later time where the entire procrastinated email thread is separated from the rest of the emails during the procrastination period. The operations may be performed by a system such as, for example, the system 202. FIG. 3 describes the operation of the system at three different time periods 302, 304 and 306. At time period 302, a new email 1-1 arrives in the inbox 308 (e.g., inbox 212), starting a new email thread 1. The email thread 1 is identified as new, for example, by being displayed in bold faced letters. Email 1-1 of the thread 1 is also displayed as new. Diagram 300 shows that at time period 302, the inbox 308 also includes an email thread 2 including an email 2-1. The email 2-1 has been already read by the user at time 302.

At time period 304, the user has read email 1-1 of thread 1 and decided to procrastinate thread 1 for review at a later time. The entire thread 1 has been moved from the inbox 308 to an archive 310. The thread 1 will be procrastinated in the archive 310 for a procrastination period. The user may specify the procrastination period when procrastinating thread 1. The user may either specify the length of procrastination, or the end time of procrastination. For example, the user may specify that he or she wishes to procrastinate the thread for “two days,” or may specify that the procrastination period end “on Tuesday.” If the user does not specify a procrastination period, a default value such as, for example, “24 hours,” may be used. The archive 310 may be located in a data repository such as, for example, the data repository 214. Emails or email threads in the archive 310 are not readily visible to the user. However, the user still has access to the emails or email threads stored in the archive 310 by, for example, performing a search. A separate user interface may also be provided for accessing the contents of the archive 310. Diagram 300 shows that during time period 304, a new email 1-2 arrives for the thread 1. Since thread 1 is being procrastinated, the email 1-2 is not delivered to the inbox 308, but instead is delivered to the archive 310 where the rest of thread 1 is being stored. The user is not separately notified of the arrival of email 1-2 until the procrastination period expires. During time period 304, thread 2 continues to be stored in inbox 308.

At time period 306, the procrastination period has expired, and the system communicates the thread 1 to the user by delivering the thread from the archive 310 back to the inbox 308. Thread 1 is indicated as including a new email by, for example, using bold faced letters. Email 1-2 is also identified as new. However, email 1-1 is not identified as new, since the user had previously read the email before deciding to procrastinate thread 1. Future emails received for thread 1 will be delivered directly to the inbox 308.

In one aspect of the invention, when the email thread 1 is procrastinated, any email of thread 1 which was already in the inbox 308 before procrastination (e.g., email 1-1) stays in the inbox 308. However, any new emails arriving for the thread 1 during the procrastination period (e.g., email 1-2) is delivered directly to the archive 310, without separately notifying the user of their arrival. After the expiration of the procrastination period, all new emails that have arrived during the procrastination period are delivered to the inbox 308.

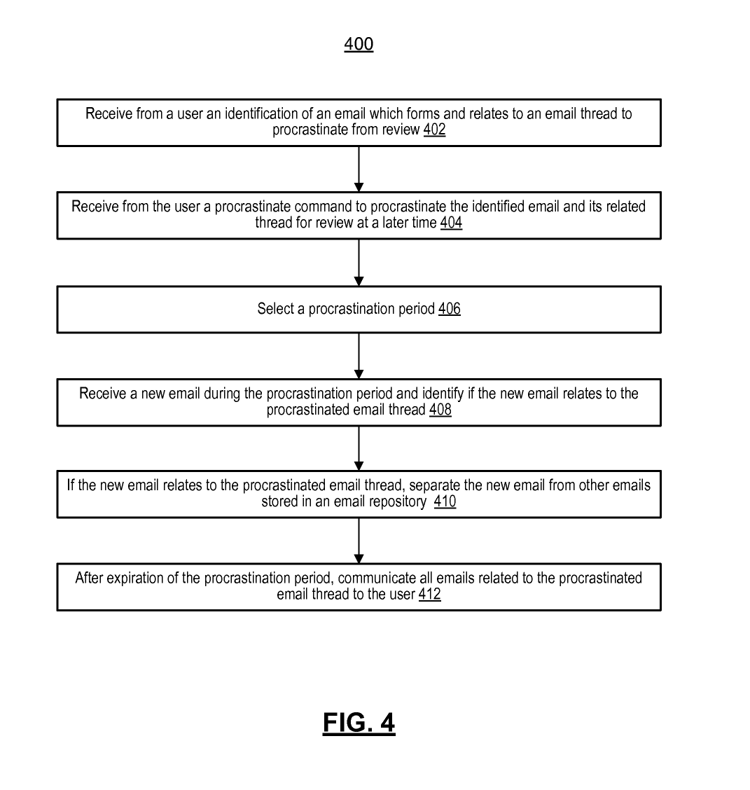

FIG. 4 illustrates an example flow diagram 400 of example processes for procrastinating email threads for review at a later time where only new messages for a procrastinated thread that arrive during the procrastination period are separately stored. The operations of FIG. 4 may be performed, for example, by the system 202.

The operation begins in step 402 where identification of an email which forms and relates to a thread to procrastinate from review is received from a user. For example, a check box is provided next to email threads available for procrastination, and the user may check the check box next to the email thread which he or she wishes to procrastinate. In step 404, a procrastinate command to procrastinate the identified email and its related thread is received from the user. For example, a button which reads “procrastinate email threads” is provided for the user to click on. The identified email and its related thread are then procrastinated for a time period. In step 406, a procrastination period for the procrastinated email thread is selected. As discussed above, the procrastination period may be received from the user, or a default value may be used. In step 408, a new email is received during the procrastination period, and identification is made if the new email relates to the procrastinated email thread. In step 410, if the new email is identified as being related to the procrastinated email in step 408, the new email is separated from the rest of the emails in an email repository. For example, rather than storing the new email in the same email repository (e.g., inbox 212, inbox 308) as the rest of the emails of the procrastinated email thread, the new email is separately stored in a different email repository (e.g., data store 214, archive 310). Emails stored in the different email repository are not readily visible to the user. The emails of the procrastinated email thread that were already in the email repository before procrastination continue to be stored in the same email repository and remain visible to the user. Even though a new email has arrived for the procrastinated email thread, during the procrastination period, it appears to the user as though no new email has been received for the thread.

After the expiration of the procrastination period, in step 412, all emails related to the procrastinated email thread is communicated to the user. For example, the new email that has been separately stored in the different email repository during the procrastination period is moved back to the email repository where the rest of the emails of the procrastinated email thread are stored.

In an aspect of the invention, rather than storing the new email of the procrastinated thread in a separate repository, it is stored in the same email repository as the rest of the emails of the procrastinated thread. However, the arrival of the new email is not notified to the user and the new email is not made visible to the user until the expiration of the procrastination period.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

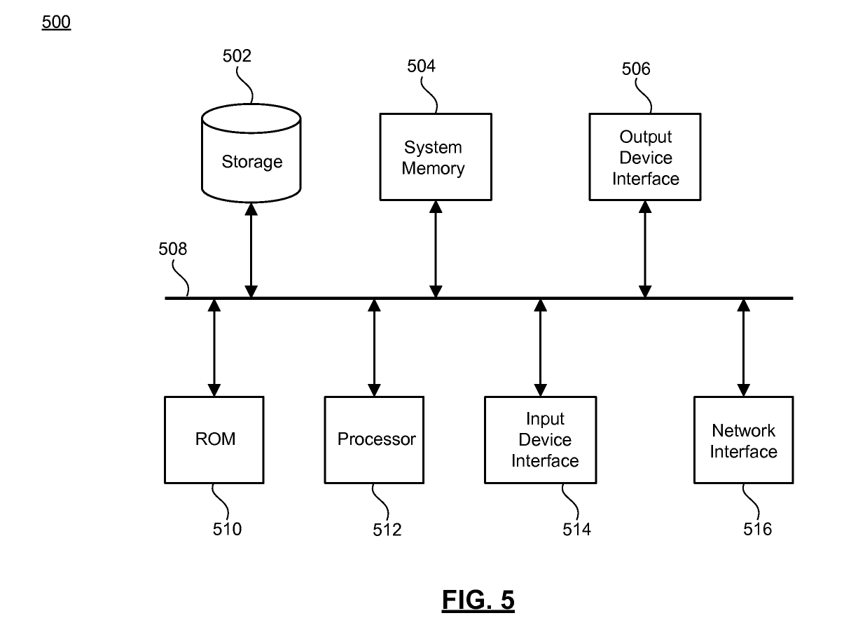

FIG. 5 conceptually illustrates an electronic system with which some implementations of the subject technology are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enable, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject technology described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Aspects of the subject technology described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject technology described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that not all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for procrastinating an email for review at a later time, the method comprising:
identifying an email for procrastination;
selecting a procrastination period;
procrastinating the identified email for review at a later time, comprising:
storing the identified email separately from other emails or email threads stored in an email repository;
receiving a new email during the procrastination period;
identifying if the new email relates to the procrastinated email to form an email thread, and if so, storing the new email with the procrastinated email as a procrastinated email thread;
preventing notification of the new email to a user; and
after expiration of the procrastination period:
marking the new email as being returned from procrastination; and
communicating all emails related to the procrastinated email thread to the user.

2. The method of claim 1, wherein the email identified for procrastination relates to an existing email thread.

3. The method of claim 1, wherein the new email in is not readily visible to the user during the procrastination period.

4. The method of claim 1, wherein in the procrastinating step, the identified email is moved from the email repository to an invisible email repository, wherein emails in the invisible email repository are not readily visible to the user.

5. The method of claim 4, wherein in the communicating step, all the emails related to the procrastinated email thread are moved from the invisible email repository to the email repository.

6. The method of claim 1, further comprising receiving a value of the procrastination period from the user, wherein in the selecting step, the procrastination period is selected based on the received value.

7. The method of claim 1, further comprising receiving an end time of the procrastination period, wherein in the selecting step, the procrastination period is selected based on the received end time.

8. The method of claim 1, wherein the email repository is an inbox.

9. The method of claim 1, further comprising receiving a search request for the new email during the procrastination period; and communicating to the user the new email during the procrastination period.

10. A system for procrastinating an email for review at a later time, the system comprising:
a memory storing a first email repository storing a plurality of emails received for a user, the memory further storing executable instructions; and
a processor coupled to the memory configured to execute the stored executable instructions to:
identify an email for procrastination;
utilize a predetermined default procrastination period;
procrastinate the identified email for review at a later time, comprising:
retain the identified email in the first email repository;
receive a new email during the procrastination period;
identify if the new email relates to the procrastinated email to form an email thread, and if so, store the new email in a second email repository different from the first email repository; and
after expiration of the procrastination period, move all new emails related to the procrastinated email from the second email repository to the first email repository.

11. The system of claim 10, wherein the new email is not readily visible to the user during the procrastination period.

12. The system of claim 10, wherein emails in the second email repository are not readily visible to the user.

13. The system of claim 10, wherein the processor is further configured to receive a value of the procrastination period from the user, wherein in the selecting step, the procrastination period is selected based on the received value.

14. The system of claim 10, wherein the processor is further configured to receive an end time of the procrastination period, wherein in the selecting step the procrastination period is selected based on the received end time.

15. The system of claim 10, wherein the first email repository is an inbox.

16. The system of claim 10, wherein the processor is further configured to receive a search request for the new email during the procrastination period; and communicate to the user the new email during the procrastination period.

17. A machine-readable storage medium comprising machine-readable instructions for causing a processor to execute a method for procrastinating an email for review at a later time, the method comprising:
identifying an email for procrastination;
selecting a procrastination period;
procrastinating the identified email for review at a later time, comprising:
moving the identified email from a first email repository to a second email repository, wherein emails stored in the second email repository are not readily visible to a user;
receiving a new email during the procrastination period;
identifying if the new email relates to the procrastinated email to form an email thread, and if so, storing the new email in the second email repository with the procrastinated email to form a procrastinated email thread;
preventing notification of the new email to a user; and
after expiration of the procrastination period, moving all emails related to the procrastinated email thread including the new email from the second email repository to the first email repository, wherein a separate marker than a new email marker is used to mark the new email from the second email repository as being returned from procrastination.

18. The machine-readable storage medium of claim 17, wherein the method further comprises receiving a value of the procrastination period from the user, wherein in the selecting step, the procrastination period is selected based on the received value.

19. The machine-readable storage medium of claim 17, wherein the method further comprises receiving an end time of the procrastination period, wherein in the selecting step, the procrastination period is selected based on the received end time.

20. The machine-readable storage medium of claim 17, wherein the method further comprises receiving a search request for the new email during the procrastination period; and communicating to the user the new email during the procrastination period.
